(19) United States
(12) Patent Application Publication
(10) Pub. No.: US 2011/0219425 A1
(43) Pub. Date: Sep. 8, 2011

(54) ACCESS CONTROL USING ROLES AND MULTI-DIMENSIONAL CONSTRAINTS

(76) Inventors: Ying Xiong, Bothwell, WA (US); Satish R. Thatte, Redmond, WA (US); Daniel James Foley, III, Redmond, WA (US); Anuj Bansal, Sammamish, WA (US); Aaron Hanks, Issaquah, WA (US); Pankaj Sharma, Redmond, WA (US); Barry Briggs, Mercer Island, WA (US); Eric Slippern, Issaquah, WA (US)

(21) Appl. No.: 12/719,025

(22) Filed: Mar. 8, 2010

(51) Int. Cl. G06F 21/00

(52) U.S. Cl. 726/1; 726/28

(57) ABSTRACT

Methods, systems, and computer-readable media of access control using roles and multi-dimensional constraints are disclosed are disclosed. A particular method includes assigning a user a particular role of a plurality of roles and associating the user with one or more multi-dimensional constraints. A request from the user to perform an operation permitted by the particular role may be received. The method includes determining whether any of the multi-dimensional constraints allows the user to perform the operation. The request is granted when at least one of the multi-dimensional constraints allows the user to perform the operation. The request is denied when none of the multi-dimensional constraints allows the user to perform the operation.

### BACKGROUND

Application security is an important consideration for multi-user enterprises. Role-based access control (RBAC) is a security model that may be used to implement application security. In RBAC, whether or not a user is permitted to execute an application is determined by whether or not the user has a role that is permitted to execute the application. One way to create a new application permission in RBAC is to create a new role. However, this may lead to a “role explosion” problem in large enterprises, where the RBAC system includes many roles that have been created for a specific purpose and a specific user. Thus, the RBAC model may not scale efficiently as the number of managed application permissions increases. Further, the RBAC model may not enable refined access control at an object level (e.g., as opposed to a role-level).

### SUMMARY

An access control framework that uses both roles as well as multi-dimensional constraints is disclosed. Users in the access control framework are assigned roles and associated with multi-dimensional constraints. Each multi-dimensional constraint may refine the scope of role permissions and user permissions in multiple dimensions. For example, two users may be assigned the same role, but may have different permissions because they are associated with different multi-dimensional constraints. During run-time at the access control framework, each access request may be role-validated and constraint-validated. By performing validation at the request level instead of the session level, the access control framework disclosed herein may handle situations in which roles and/or constraints have been modified at run-time.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram to illustrate a particular embodiment of a system of access control using roles and multi-dimensional constraints;

FIG. 2 is a diagram to illustrate a particular embodiment of extended role-based access control (RBAC) that includes multi-dimensional constraints, request-level role validation, and request-level constraint validation;

FIG. 3 is diagram to illustrate a particular embodiment of roles and multi-dimensional constraints;

FIG. 4 is a diagram to illustrate another particular embodiment of roles and multi-dimensional constraints;

FIG. 5 is a flow diagram to illustrate a particular embodiment of a method of access control using roles and multi-dimensional constraints;

FIG. 6 is a flow diagram to illustrate another particular embodiment of a method of access control using roles and multi-dimensional constraints; and

FIG. 7 is a block diagram of a computing environment including a computing device operable to support embodiments of computer-implemented methods, computer program products, and system components as illustrated in FIGS. 1-6.

### DETAILED DESCRIPTION

Systems, methods, and computer-readable media to perform access control using roles and multi-dimensional constraints are disclosed. In a particular embodiment, a computer-implemented method includes assigning a user a particular role of a plurality of roles in an access control system. The method also includes associating the user with one or more multi-dimensional constraints. The method further includes receiving a request from the user to perform an operation permitted by the particular role. The method includes determining whether any of one or more multi-dimensional constraints allows the user to perform the operation. The method also includes granting the request when one of the one or more multi-dimensional constraints allows the user to perform the operation. The method further includes denying the request when none of the one or more multi-dimensional constraints allows the user to perform the operation.

In another particular embodiment, a computer-readable medium includes instructions, that when executed by a computer, cause the computer to assign a first user a particular role of a plurality of roles and to assign a second user the particular role. The instructions also cause the computer to associate the first user with a first multi-dimensional constraint and to associate the second user with a second multi-dimensional constraint. The first multi-dimensional constraint defines access restrictions with respect to the first user in a plurality of dimensions and the second multi-dimensional constraint defines access restrictions with respect to the second user in the plurality of dimensions. The instructions further cause the computer to receive a first request from the first user to perform an operation permitted by the role and to receive a second request from the second user to perform the operation permitted by the role. The first multi-dimensional constraint allows the first user to perform the operation but the second multi-dimensional constraint does not allow the second user to perform the operation. The instructions cause the computer to grant the first request and to deny the second request.

In another particular embodiment, a computer system includes a processor and a memory coupled to the processor. The memory stores instructions, that when executed by the processor, cause the processor to execute a security system. The security system includes a plurality of permissions, an administration module, and a run-time module. Each permission enables performance of a particular operation of a plurality of operations with respect to a particular object of a plurality of objects or a particular messaging event of a plurality of messaging events. The administration module is configured to assign one or more roles to each user of a plurality of users. The administration module is also configured to determine one or more dimensions based on the plurality of objects or messaging events and to determine one or more multi-dimensional constraints based on the one or more dimensions. Each multi-dimensional constraint restricts a permission associated with one or more of a role and a user. The administration module is further configured to associate each of the plurality of users with one or more of the plurality of multi-dimensional constraints with respect to the particular role. The run-time module is configured to receive an access request from a particular user during a session of the security system. The run-time module is also configured to perform a role validation and a constraint validation. The role validation includes determining whether the particular user is assigned a role that permits the access request. The constraint validation includes determining whether the particular user is associated with a multi-dimensional constraint that allows the particular user to complete the access request. The run-time module is further configured to grant or deny the access request based on the role validation and the constraint validation.

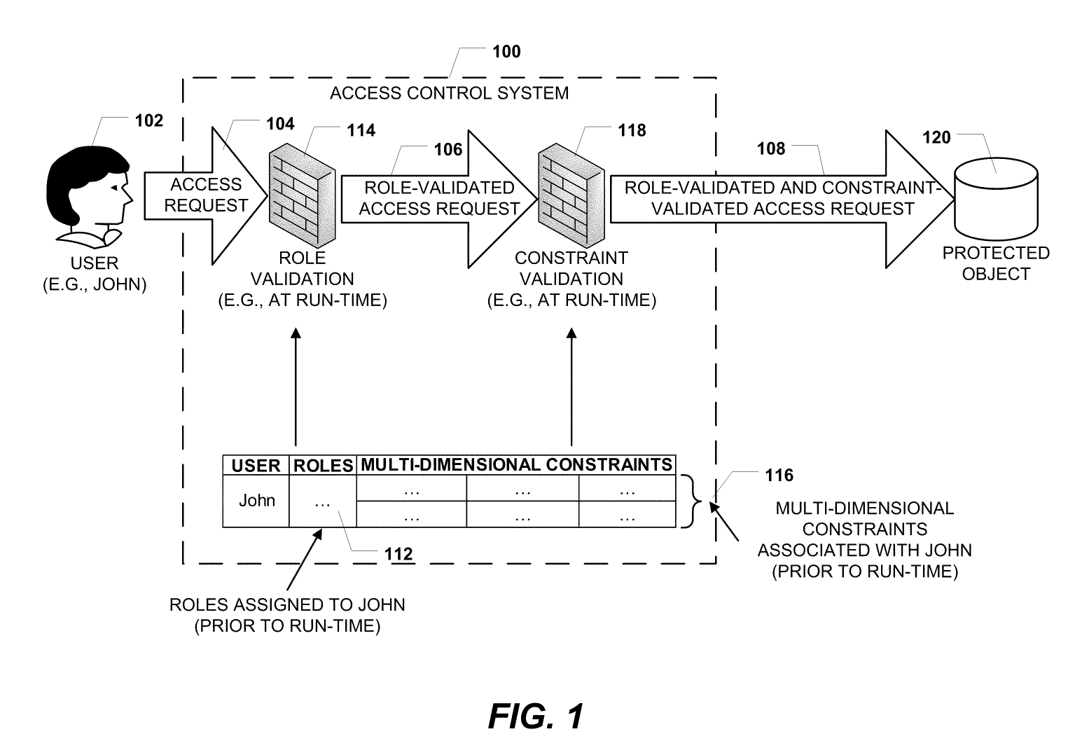

FIG. 1 depicts a particular embodiment of an access control system 100 that uses roles and multi-dimensional constraints. Generally, the access control system 100 may grant users (e.g., an illustrative user 102) selective access to protected objects (e.g., an illustrative protected object 120).

Prior to run-time (e.g., during an administration time) at the access control system 100, each user may be assigned one or more roles. For example, the access control system 100 may support a plurality of roles and the user 102 (e.g., John) may be assigned one or more roles 112. It should be noted that any user may be assigned any number of roles. Users may also be associated with one or more multi-dimensional constraints prior to run-time at the access control system 100. For example, the user 102 may be associated with the multi-dimensional constraints 116. In a particular embodiment, each multi-dimensional constraint defines access permissions and/or restrictions with respect to a plurality of dimensions. For example, the dimensions may include geographic dimensions, numeric dimensions, time dimensions, membership dimensions, hierarchical dimensions, or some combination thereof. For example, a particular three-dimensional constraint may allow a user to access only those database tables that include data in particular geographic (e.g., North America), numeric (e.g., clients having less than 500 employees), and membership (e.g., clients that are members of the “small business” set) dimensions. It should be noted that the geographic dimension “North America” may also be a hierarchical dimension. For example, the dimension “North America” may include the sub-dimensions “USA,” “Canada,” “Mexico,” and “Central America.”

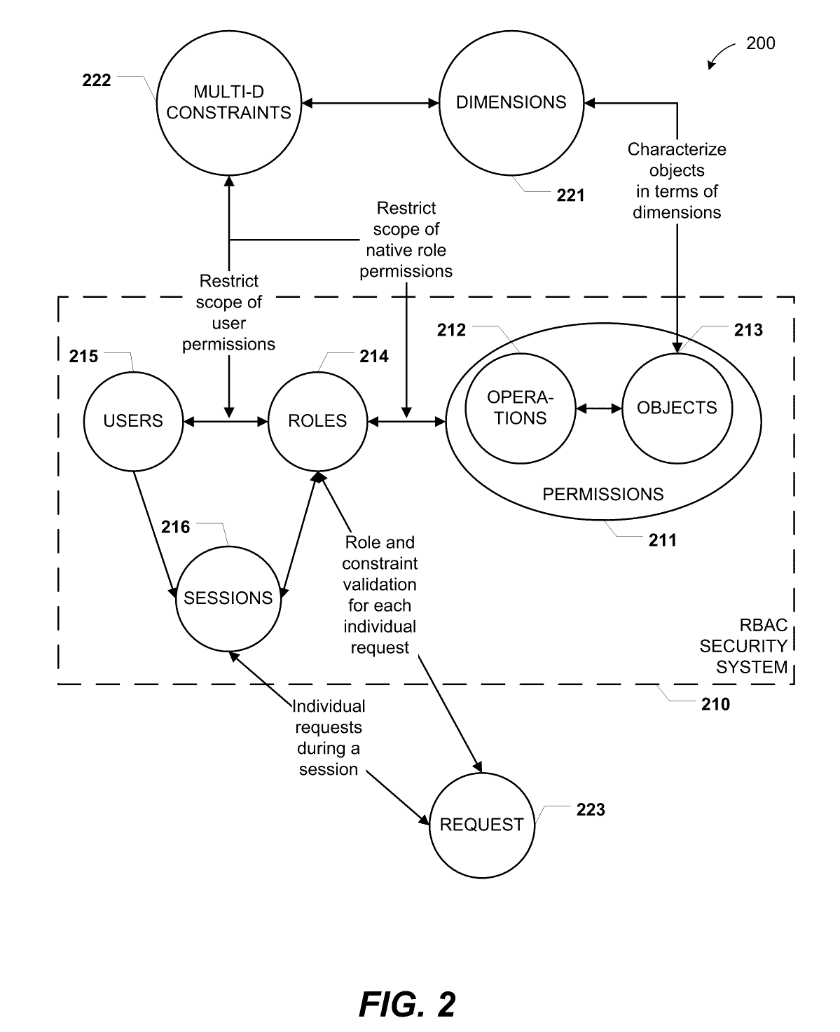

In a particular embodiment, the dimensions include an enterprise dimension (e.g., time or location) that is applicable to all roles at the access control system 100. In another particular embodiment, roles are associated with native multi-dimensional constraints. For example, if a particular role is associated with a particular native multi-dimensional constraint, each user assigned the particular role may automatically be associated (e.g., by inheritance) with the native multi-dimensional constraint. Native multi-dimensional constraints may be overwritten on a per-user basis or may be immutable. Multi-dimensional constraints are further described and illustrated with respect to FIGS. 2-4.

The access control system 100 may be configured to perform role validation 114 and constraint validation 118 on access requests (e.g., an illustrative access request 104) received during run-time. For example, the user 102 may make the access request 104 to perform a particular operation (e.g., read, write, copy, delete, or share) with respect to the protected object 120. The role validation 114 may determine whether one of the roles 112 permits the access request 104, and the constraint validation 118 may determine whether any of the multi-dimensional constraints 116 permits the operation. In a particular embodiment, the access request 104 first undergoes the role validation 114. If the role validation 114 is successful, a resulting role-validated access request 106 then undergoes the constraint validation 118. If the constraint validation 118 is also successful, a resulting role-validated and constraint-validated request 108 may be granted (e.g., the user 102 may be granted access to the protected object 120). If either the role validation 114 or the constraint validation 118 is unsuccessful, the access request 104 may be denied. In another particular embodiment, the order of the role validation 114 and constraint validation 118 are reversed.

In a particular embodiment, users are assigned roles and associated with multi-dimensional constraints by an administration module of the access control system 100. In another particular embodiment, the role validation 114 and the constraint validation 118 are performed by a run-time module of the access control system 100. In a particular embodiment, a role-validated and constraint-validated request may nonetheless be denied. For example, the protected object 120 may support a maximum number of users or the access control system 100 may restrict access to the protected object 120 during a particular session to a maximum number of users assigned a particular role. In such an embodiment, the access control system 100 may deny an access request if the number of other users that have already been granted access to the particular object exceeds a threshold.

In operation, users of the access control system 100 may be assigned roles and associated with multi-dimensional constraints during an administration time period. For example, the user 102 may be assigned one or more roles 112 and may be associated with one or more multi-dimensional constraints 116. The access control system 100 may receive access requests during run-time. For example, the access control system 100 may receive an access request 104 from the user 102 to perform a particular operation on the protected object 120. The access control system 100 may perform role validation 114 and constraint validation 118 on the access request. If both the role validation 114 and constraint validation 118 are successful (e.g., one of the roles 112 and the multi-dimensional constraints 116 permit completion of the operation), the access request 104 may be granted.

It will be appreciated that the system 100 of FIG. 1 may perform role-validation and constraint-validation for each received access request and may provide object level access control. Thus, the system 100 of FIG. 1 may handle run-time situations in which a user's role assignments change, the permissions associated with a role change, and multi-dimensional constraints change. For example, even though a first request from a user is granted, a subsequently received second request from the user during the same session may be denied because either the role-validation or the constraint-validation failed with respect to the second request. It will also be appreciated that because multi-dimensional constraints may be associated with users independently of role assignment and a single multi-dimensional constraint may be applicable to multiple roles, the system of FIG. 1 may be integrated with existing RBAC systems with little or no modification of pre-existing roles and role assignments.

FIG. 2 is a diagram to illustrate a particular embodiment of an extended role-based access control (RBAC) system 200 that includes multi-dimensional constraints, role validation, and constraint validation.

An RBAC security system 210 may include a plurality of permissions 211, where each particular permission enables the performance of a particular operation of a plurality of operations 212 on a particular object of a plurality of objects 213. Generally, the RBAC security system 210 may determine whether a particular user of a plurality of users 215 has permission to perform a particular operation on a particular object.

Each user of the plurality of users 215 may be assigned one or more roles of a plurality of roles 214. To perform operations on objects, a user may initiate a session of the RBAC security system 210. Similarly, a second user may initiate a second session of the RBAC security system 210. Thus, a plurality of concurrent sessions 216 may be supported by the RBAC security system.

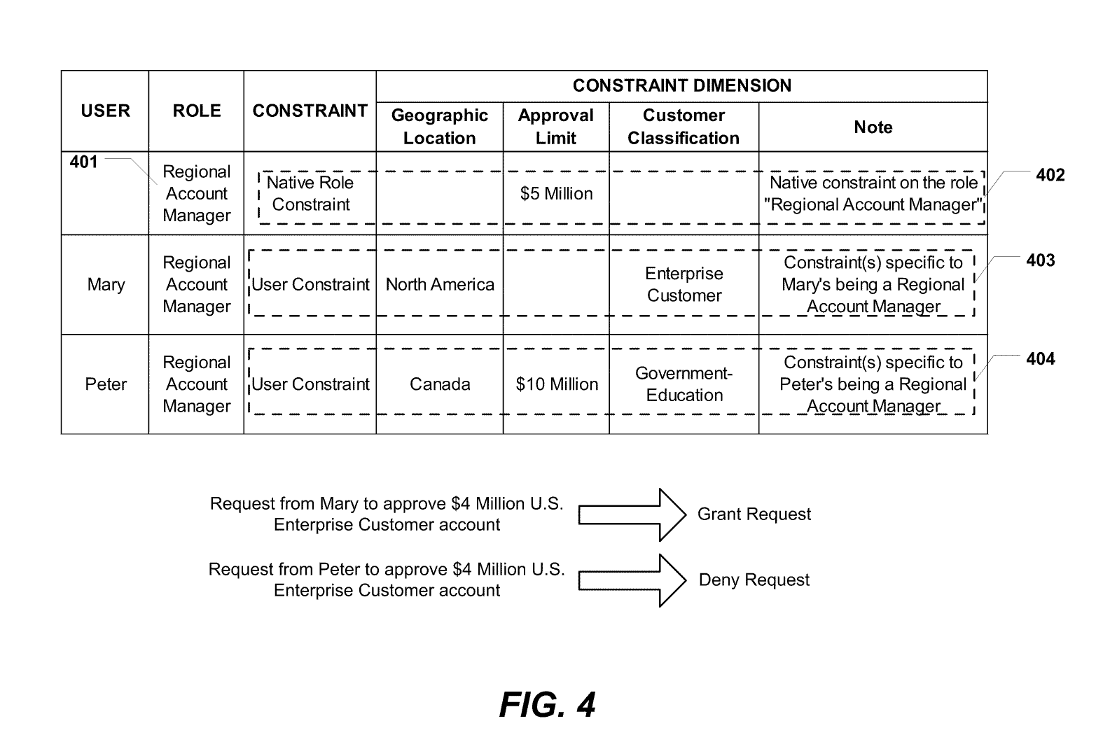

The RBAC security system 210 may be extended by implementing multi-dimensional constraints. For example, prior to run-time at the RBAC security system 210, each of the objects 213 may be characterized in terms of dimensions. A resulting universe of dimensions 221 may thus be formed. Multi-dimensional constraints 222 may be defined (e.g., by an administrator of the RBAC security system 210), where each of the multi-dimensional constraints 222 defines permissions in two or more of the dimensions 221. The multi-dimensional constraints 222 may include native constraints that restrict the scope of native role permissions. For example, a role “Regional Account Manager” may have a native role permission that allows users assigned the “Regional Account Manager” role to approve any customer account. If an enterprise decision is subsequently made to limit regional account manager approvals to only those customer accounts having a total value of less than $5 million, a multi-dimensional constraint may be defined that restricts the scope of the native role permission to accounts valued at less than $5 million. Restricting the scope of native role permissions is further described and illustrated with reference to FIG. 4.

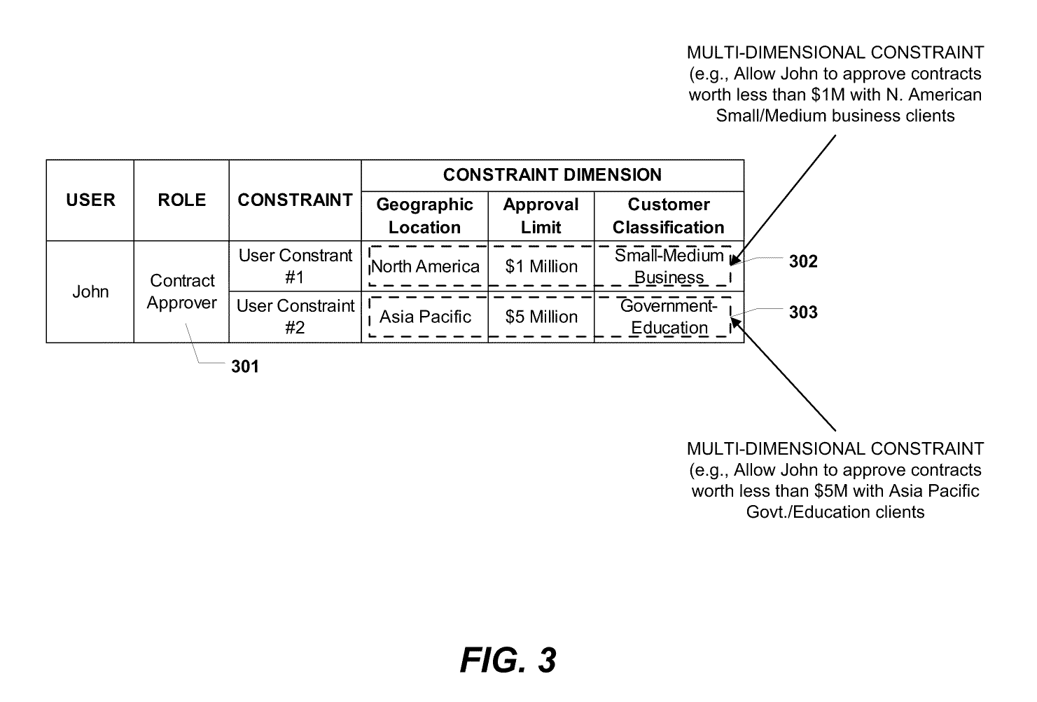

The multi-dimensional constraints may also restrict the scope of user permissions. For example, two users (e.g., Bob and Mike) may be assigned the same role (e.g., “Contract Approver”), but multi-dimensional constraints may limit the users to performing the same action (e.g., contract approval) on a different set of objects (e.g., Bob is only allowed to approve European contracts and Mike is only allowed to approve South American contracts). Restricting the scope of user permissions is further described and illustrated with reference to FIGS. 3-4.

The RBAC security system 210 may also be extended by implementing dynamic request validation. For example, instead of just validating a user's role at the start of each session, each individual request 223 made during a session may be independently role-validated and constraint-validated.

It will be appreciated that extending the RBAC security system by implementing multi-dimensional constraints may enable access control at the individual object level instead of the role level. For example, even though two users are assigned the same role, multi-dimensional constraints may allow only one of the users to access a particular object. It will also be appreciated that extending the RBAC system by implementing dynamic request validation may enable run-time permission changes, thereby resulting in a more fluid operation of an enterprise security system.

FIG. 3 is a diagram to illustrate a particular embodiment of roles and multi-dimensional constraints.

As illustrated in FIG. 3, users may be assigned one or more roles. For example, in FIG. 3, John is assigned the role 301 “Contract Approver.” Users may also be associated with multi-dimensional constraints that restrict permissions granted by the roles. For example, in FIG. 3, John is associated with two multi-dimensional constraints 302 and 303, each of which includes a geographic dimension, a numeric dimension, and a membership dimension. A first multi-dimensional constraint 302 allows John to approve contracts worth less than $1 million with North American small or medium business customers. A second multi-dimensional constraint 303 allows John to approve contracts worth less than $5 million with Asia Pacific government or education customers.

In operation, based on the role 301 and the multi-dimensional constraints 302-303, a security system may permit John to approve a $20,000 contract with a small business in Seattle, Wash. and a $4 million dollar contract with a university in Fiji. However, John may be restricted from approving any contract not expressly permitted by one of the multi-dimensional constraints 302-303 (e.g., any contract in South America or any contract with large business customers).

It should be noted that although the multi-dimensional constraints 302-303 include the same dimensions, different multi-dimensional constraints that apply to the same role may include different dimensions.

FIG. 4 is a diagram to illustrate another particular embodiment of roles and multi-dimensional constraints.

As illustrated in FIG. 4, users may be assigned one or more roles. For example, in FIG. 4, Mary and Peter are assigned the role 401 “Regional Account Manager.” The Regional Account Manager role 401 is associated with a multi-dimensional constraint that is a native role constraint 402. The native role constraint 402 limits all users assigned the role 401 of Regional Account Manager to approving only those customer accounts valued less than $5 million.

Users may also be associated with multi-dimensional constraints. For example, in FIG. 4, Mary is associated with a first user constraint 403 and Peter is associated with a second user constraint 404. The first user constraint 403 allows Mary to approve all North American enterprise customer accounts. Thus, because both the native role constraint 402 and the first user constraint 403 apply to Mary, a security system may conclude that Mary has permission to approve North American enterprise customer accounts valued at less than $5 million.

The second user constraint 404 allows Peter to approve all Canadian government/education accounts valued at $10 million or less. It will be noted that with respect to Peter, the approval limit of $10 million indicated by the second user constraint 404 conflicts with the approval limit of $5 million indicated by the native role constraint 402. In a particular embodiment, when a user constraint conflicts with a native role constraint, the conflicting dimension in the user constraint is ignored or not permitted. That is, although the approval limit indicated in the second user constraint 404 is $10 million, Peter will nonetheless be allowed to approve only those Canadian government/education accounts that are valued at $5 million or less. In an alternate embodiment, user constraints may be used to override native role constraints. In this scenario, even though Peter is a Regional Account manager, Peter will be allowed to approve Canadian government/education accounts valued up to $10 million. However, Peter's ability to approve other types of accounts (i.e., contracts that are not with Canadian government-education customers) may be limited to $5 million valuations.

In operation, based on the role 401 and the multi-dimensional constraints 402-404, a security system may respond differently to the same request received from two users assigned the same role. For example, a request from Mary to approve a $4 million US enterprise customer account may be granted, but a request from Peter to approve the same $4 million US enterprise customer account may be denied.

It should be noted that although the particular embodiments depicted in FIGS. 1-4 are described with reference to an object access control system, the access control framework described may be implemented for any resource or task. For example, role-based and multi-dimensional constraint-based access control may be implemented for a messaging event system. Roles at a messaging event system may include one or more publisher roles and one or more subscriber roles. Furthermore, multi-dimensional constraints at a messaging event system may include message publication constraints and message subscription constraints. For example, multi-dimensional constraints in a messaging event system may include message content restrictions and message type restrictions.

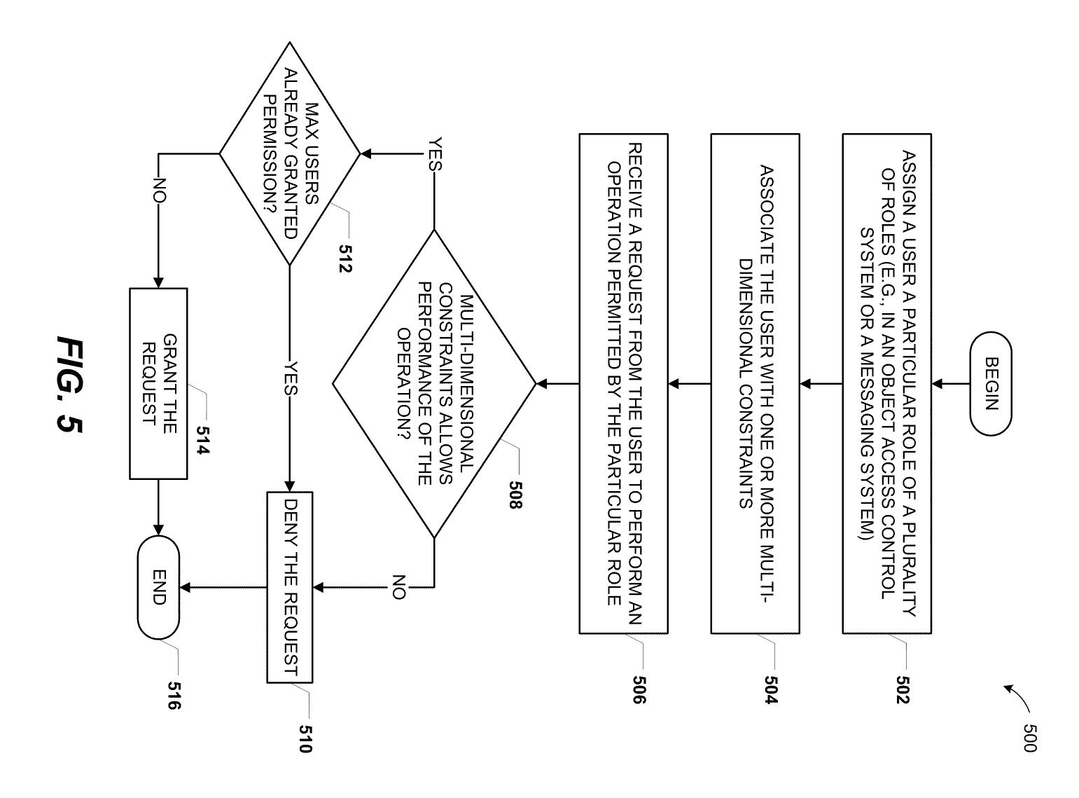

FIG. 5 is a flow diagram to illustrate a particular embodiment of a method 500 of access control using roles and multi-dimensional constraints. In an illustrative embodiment, the method 500 may be performed by the system 100 of FIG. 1 or the system 200 of FIG. 2.

The method 500 includes assigning a user a particular role of a plurality of roles, at 502. The roles may be part of an object access control system or a messaging system. For example, in FIG. 1, the user 102 may be assigned the roles 112. The method 500 also includes associating the user with one or more multi-dimensional constraints. For example, in FIG. 1, the user 102 may be associated with the multi-dimensional constraints 116. The method 500 further includes receiving a request from the user to perform an operation permitted by the particular role, at 506. For example, in FIG. 1, the access request 104 may be received from the user 102.

The method 500 includes determining whether any of the multi-dimensional constraints allows performance of the operation, at 508. For example, in FIG. 1, the constraint validation 118 may determine whether any of the multi-dimensional constraints 116 allows the user 102 to perform the operation. If it is determined that none of the multi-dimensional constraints allows performance of the operation, the method 500 includes denying the request, at 510.

If it is determined that at least one of the multi-dimensional constraints allows performance of the operation, the method 500 includes determining whether a maximum number of users have already been granted the same permission, at 512. If it is determined that the maximum number of users have been granted the same permission, the method 500 includes denying the request, at 510. If it is determined that the maximum number of users have not been granted the same permission, the method 500 includes granting the request, at 514. For example, in FIG. 1, the access request 104 may be granted. After the request is denied at 510 or granted at 514, the method 500 determinates at 516.

In a particular embodiment, the method 500 also includes role validation. For example, the method 500 may include verifying that the user is assigned the role at the time of the request. Run-time role-validation may enable the method 500 to be used at access control systems that include run-time role changes. For example, the method 500 may correctly control access at systems where users may be unassigned and reassigned roles during run-time.

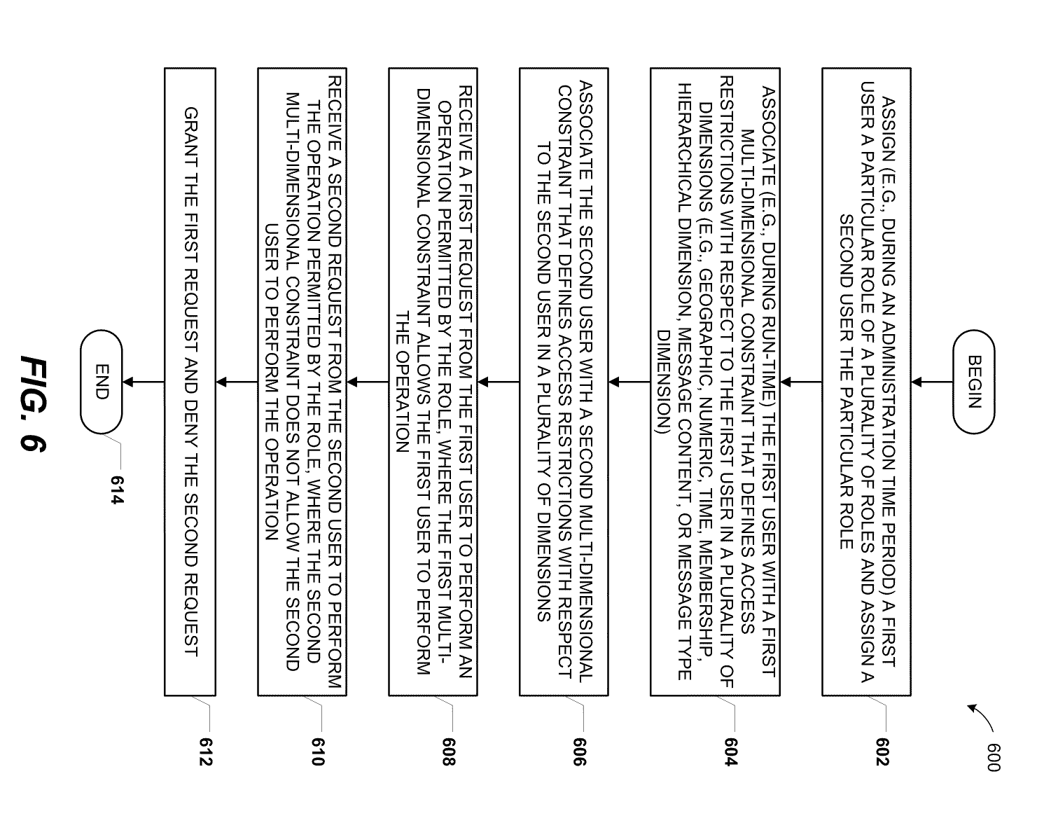

FIG. 6 is a flow diagram to illustrate another particular embodiment of a method 600 of access control using roles and multi-dimensional constraints. In an illustrative embodiment, the method 600 may be performed by the system 100 of FIG. 1 or the system 200 of FIG. 2 and use of the method 600 may be illustrated by reference to FIG. 4.

The method 600 includes assigning a first user and a second user a particular role of a plurality of roles, at 602. In a particular embodiment, the role is assigned during an administration time period. For example, referring to FIG. 4, both Mary and Peter may be assigned the role “Regional Account Manager.” The method 600 also includes associating the first user with a first multi-dimensional constraint that defines access restrictions with respect to the first user in a plurality of dimensions, at 604. The method 600 further includes associating the second user with a second multi-dimensional constraint that defines access restrictions with respect to the second user in a plurality of dimensions, at 606. For example, referring to FIG. 4, Mary may be associated with the first user constraint 403 and Peter may be associated with the second user constraint 404.

It should be noted that when the method 600 is performed at an object access control system, multi-dimensional constraints may include geographic dimensions, numeric dimensions, time dimensions, membership dimensions, hierarchical dimensions, or a combination thereof. When the method 600 is performed at a messaging system, multi-dimensional constraints may include message content dimensions, message type dimensions, or a combination thereof.

The method 600 includes receiving a first request from the first user to perform an operation permitted by the role, at 608, and receiving a second request from the second user to perform the operation permitted by the role, at 610. The first multi-dimensional constraint allows the first user to perform the operation but the second multi-dimensional constraint does not allow the second user to perform the operation. For example, referring to FIG. 4, both Mary and Peter may submit a request to approve a $4 million US customer account.

The method 600 includes granting the first request and denying the second request, at 612. For example, referring to FIG. 4, Mary's request may be granted and Peter's request may be denied. The method 600 terminates at 614.

It should be noted that the embodiments illustrated and described with respect to FIGS. 1-6 may implement a positive policy. In a positive policy, multi-dimensional constraints may define what a user is allowed to do, and a request may be granted as long as one multi-dimensional constraint allows the user to perform an operation. In alternate embodiments, a negative policy may be implemented. In a negative policy, multi-dimensional constraints may instead define what a user is not allowed to do, and a request may be granted when no multi-dimensional constraint restricts the user from performing the operation.

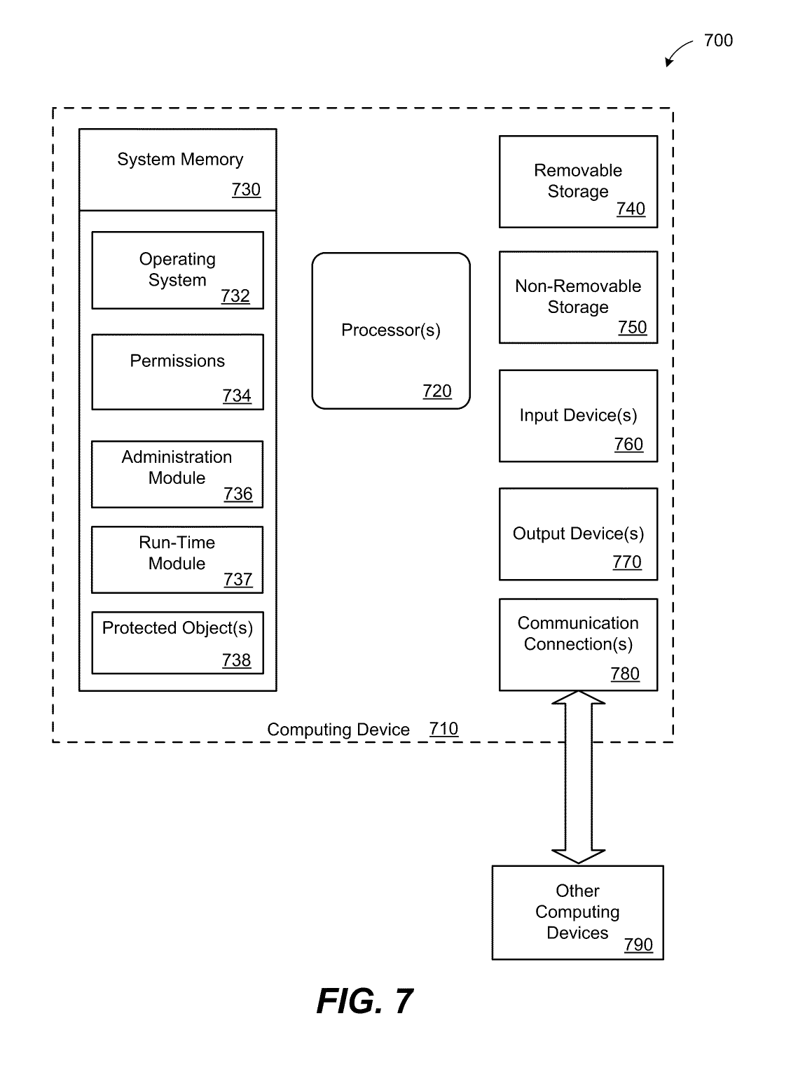

FIG. 7 depicts a block diagram of a computing environment 700 including a computing device 710 operable to support embodiments of computer-implemented methods, computer program products, and system components according to the present disclosure. In an illustrative embodiment, the computing device 710 may include one or more of the access control system 100 of FIG. 1 and the protected object 120 of FIG. 1. Each of the access control system 100 of FIG. 1 and the protected object 120 of FIG. 1 may include or be implemented using the computing device 710 or a portion thereof. The computing device 710 may also include stored representations of one or more of the permissions 211 of FIG. 2, the operations 212 of FIG. 2, the objects 213 of FIG. 2, the roles 214 of FIG. 2, the users 215 of FIG. 2, the sessions 216 of FIG. 2, the dimensions 221 of FIG. 2, the multi-dimensional constraints 222 of FIG. 2, and the request 223 of FIG. 2.

The computing device 710 includes at least one processor 720 and a system memory 730. Depending on the configuration and type of computing device, the system memory 730 may be volatile (such as random access memory or “RAM”), non-volatile (such as read-only memory or “ROM,” flash memory, and similar memory devices that maintain stored data even when power is not provided), or some combination of the two. The system memory 730 typically includes an operating system 732, one or more application platforms, one or more applications, and program data. For example, the system memory 730 may include permissions 734, an administration module 736, and a run-time module 737 of a security application configured to grant or deny access requests with respect to one or more protected objects 738. The permissions 734 may enable the performance of particular operations on the one or more protected objects 738. In an illustrative embodiment, the permissions 734 include the permissions 211 of FIG. 2. In another illustrative embodiment, the one or more protected objects 738 include the protected object 120 of FIG. 1. In an alternate embodiment, the protected objects 738 may be stored external to the computing device 710.

In a particular embodiment, the administration module 736 may assign roles to users and may associate users with multi-dimensional constraints that restrict one or more of the permissions 734 (e.g., native role constraints or user constraints). The run-time module 737 may receive access requests for the protected objects 738, may perform role validation and constraint validation on access requests, and may grant or deny access requests based on the results of the role validation and the constraint validation.

The computing device 710 may also have additional features or functionality. For example, the computing device 710 may also include removable and/or non-removable additional data storage devices such as magnetic disks, optical disks, tape, and standard-sized or flash memory cards. Such additional storage is illustrated in FIG. 7 by removable storage 740 and non-removable storage 750. Computer storage media may include volatile and/or non-volatile storage and removable and/or non-removable media implemented in any technology for storage of information such as computer-readable instructions, data structures, program components or other data. The system memory 730, the removable storage 740 and the non-removable storage 750 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 710. Any such computer storage media may be part of the computing device 710.

The computing device 710 may also have input device(s) 760, such as a keyboard, mouse, pen, voice input device, touch input device, etc. Output device(s) 770, such as a display, speakers, printer, etc. may also be included. The computing device 710 also contains one or more communication connections 780 that allow the computing device 710 to communicate with other computing devices 790 over a wired or a wireless network. For example, one of the other computer devices 790 may store the protected object 120 of FIG. 1 or the one or more protected objects 738.

It will be appreciated that not all of the components or devices illustrated in FIG. 7 or otherwise described in the previous paragraphs are necessary to support embodiments as herein described. For example, the removable storage 740 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A computer-implemented method, comprising:
assigning a user a particular role of a plurality of roles in an access control system;
associating the user with one or more multi-dimensional constraints;
receiving a request from the user to perform an operation permitted by the particular role;
determining whether any of one or more multi-dimensional constraints allows the user to perform the operation;
granting the request when one of the one or more multi-dimensional constraints allows the user to perform the operation; and
denying the request when none of the one or more multi-dimensional constraints allows the user to perform the operation.

2. The computer-implemented method of claim 1, wherein the user is assigned the particular role during an administration time period of the access control system.

3. The computer-implemented method of claim 2, wherein the request is received during a run-time of the access control system, the method further comprising verifying that the user is assigned the particular role prior to granting the request.

4. The computer-implemented method of claim 3, further comprising denying the request when the user is not assigned the particular role.

5. The computer-implemented method of claim 1, wherein each of the multi-dimensional constraints defines access restrictions with respect to a plurality of dimensions.

6. The computer-implemented method of claim 5, wherein the plurality of dimensions includes a geographic dimension, a numeric dimension, a time dimension, a membership dimension, or any combination thereof.

7. The computer-implemented method of claim 6, wherein at least one dimension of the plurality of dimensions is a hierarchical dimension.

8. The computer-implemented method of claim 1, wherein at least one of the multi-dimensional constraints includes an enterprise dimension that is applicable to all roles of the access control system.

9. The computer-implemented method of claim 1, wherein the role is associated with at least one native multi-dimensional constraint that is automatically associated with each user that is assigned the particular role.

10. The computer-implemented method of claim 1, wherein the operation is performed on a protected object of the access control system, the method further comprising denying the request when a number of other users assigned the particular role and granted access to the protected object exceeds a threshold.

11. The computer-implemented method of claim 1, further comprising:
receiving a second request from the user to perform the operation;
determining, with respect to the second request, whether any of the one or multi-dimensional constraints allows the user to perform the operation; and
granting or denying the second request based on the determination with respect to the second request.

12. The computer-implemented method of claim 1, wherein the first request and the second request are received during a single session of the access control system.

13. A computer-readable medium comprising instructions, that when executed by a computer, cause the computer to:
assign a first user a particular role of a plurality of roles;
assign a second user the particular role;
associate the first user with a first multi-dimensional constraint that defines access restrictions with respect to the first user in a plurality of dimensions;
associate the second user with a second multi-dimensional constraint that defines access restrictions with respect to the second user in the plurality of dimensions;
receive a first request from the first user to perform an operation permitted by the role, wherein the first multi-dimensional constraint allows the first user to perform the operation;
receive a second request from the second user to perform the operation permitted by the role, wherein the second multi-dimensional constraint does not allow the second user to perform the operation;
grant the first request; and
deny the second request.

14. The computer-readable medium of claim 13, wherein the plurality of roles is associated with an object access control system.

15. The computer-readable medium of claim 14, wherein the object access control system is a role-based access control (RBAC) system.

16. The computer-readable medium of claim 13, wherein the plurality of roles is associated with a messaging event system and wherein the plurality of rules includes at least one publisher role and at least one subscriber role.

17. The computer-readable medium of claim 16, wherein at least one of the first multi-dimensional constraint and the second multi-dimensional constraint is a message publication constraint, a message subscription constraint, or any combination thereof.

18. The computer-readable medium of claim 17, wherein at least one of the first multi-dimensional constraint and the second multi-dimensional constraint includes a message content restriction, a message type restriction, or any combination thereof.

19. A computer system, comprising:
a processor;
a memory coupled to the processor, the memory comprising instructions, that when executed by the processor, cause the processor to execute a security system comprising:
a plurality of permissions, each permission enabling performance of a particular operation of a plurality of operations with respect to a particular object of a plurality of objects or a particular messaging event of a plurality of messaging events;
an administration module configured to:
assign one or more roles to each user of a plurality of users;
determine one or more dimensions based on the plurality of objects or messaging events;
determine one or more multi-dimensional constraints based on the one or more dimensions, each multi-dimensional constraint restricting a permission associated with one or more of a role and a user; and
associate each of the plurality of users with one or more of the plurality of multi-dimensional constraints with respect to the particular role; and
a run-time module configured to:
receive an access request from a particular user during a session of the security system;
perform a role validation comprising determining whether the particular user is assigned a role that permits the access request;
perform a constraint validation comprising determining whether the particular user is associated with a multi-dimensional constraint that allows the particular user to complete the access request; and
grant or deny the access request based on the role validation and the constraint validation.

20. The computer-system of claim 19, wherein the run-time module is further configured to perform role validation and constraint validation each time an access request is received.
